(19) United States
(12) Patent Application Publication
(10) Pub. No.: US 2004/0017579 A1
(43) Pub. Date: Jan. 29, 2004

(54) Method and apparatus for enhancement of digital image quality

(75) Inventor: Sung-hyun Lim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/370,110

(22) Filed: Feb. 21, 2003

(30) Foreign Application Priority Data
Jul. 27, 2002 (KR) 2002-44489

(51) Int. Cl. G06K 1/00; G06F 15/00; H04N 1/40

(52) U.S. Cl. 358/1.9; 358/448

(57) ABSTRACT

A digital image quality enhancement method and apparatus convert RGB color data of a pixel of interest into color data having a brightness component and a saturation component, and segment the pixel of interest into a background pixel, an image pixel, or a text pixel using the brightness component and the saturation component. The method and apparatus label the pixel of interest as a text area, a background area, or an image area using history information regarding the pixel of interest, where the history information is a number of successive background pixels or image pixels before the pixel of interest. An image quality of the pixel of interest is enhanced to degrees corresponding to the area labeled and the method determines whether the pixel of interest is a final pixel of which an image quality is to be improved.

### CROSS-REFERENCE TO RELATED APPLICATIONS

This application claims the benefit of Korean Application No. 2002-44489, filed Jul. 27, 2002, in the Korean Intellectual Property Office, the disclosure of which is incorporated herein by reference.

### BACKGROUND OF THE INVENTION

1. Field of the Invention

The present invention relates to image processing applications used to obtain a printer output with an improved quality including combined text and image, where the text and image is scanned and input by an image input device, and more particularly, to an image quality enhancement method and apparatus, in which an image area and a non-image area from a document, including combined text and image, are accurately distinguished from each other, and the distinguished areas are emphasized to different degrees to obtain an improved image quality output.

2. Description of the Related Art

FIG. 1 is a block diagram of an image processing system disclosed in U.S. Pat. No. 4,996,603, which is a conventional image processing system for processing a document including a combination of a text and an image, by separating the text from the image.

In FIG. 1, the conventional image processing system includes a character/photo separation circuit 1, a fixed slice processing circuit 5 for slicing a pixel determined as a character by a predetermined fixed threshold level, and a half-tone processing circuit 6 for half-tone processing a pixel determined as the image. The character/photo separation circuit 1 includes a successive black color detection circuit 2, a successive gray color detection circuit 3, and a fine line detection circuit 4, and separates the text from the image based on a number of successive pixels with a brightness value greater than a threshold. The character/photo separation circuit uses two thresholds. A first threshold is a threshold Th0 close to white, and a second threshold is a threshold Th1 close to black. The successive gray color detection circuit 3 uses the threshold Th0. The text is separated from the image according to whether at least a predetermined number of pixels with brightness equal to or less than the threshold Th0 appear in succession. The threshold Th1 is used in the successive black color detection circuit 2. If at least a predetermined number of dark pixels with brightness equal to or less than the threshold Th1 appear in succession, the predetermined number of dark pixels are classified as successive black thick lines. Characters or the black thick lines undergo fixed slicing so that the brightness values of successive pixels, regardless of the characteristics of adjacent pixels, are converted into a uniform value of a complete white color or a complete black color. Meanwhile, an image area undergoes halftone processing.

Halftone processing is utilized to print a black and white picture on newspaper, magazines, or the like. Based on the halftone processing, a binary apparatus obtains a binary output, that is, an output only expressed in two steps, that is, black and white, and provides gray scale images.

FIG. 2 shows a 2×2 division area and dot configurations to obtain five black/white gray scale steps in order to illustrate an example of the half-tone processing. For example, the binary output apparatus requires 2×2 pixel blocks in order to create 5 black/white steps in a range from white to black. That is, an n×n block of binary pixels can express a (n²+1) number of black/white steps. That is, a number of techniques for filling n×n blocks are implemented as n²+1 patterns.

Although the half-tone technique actually degrades a resolution by blocking the document into predetermined division areas, the half-tone technique is suitable as a rough image processing technique to be used in the binary apparatus incapable of actual high-quality gray scale outputting. However, gray scale images output by the half-tone processing are not authentic successive gray scale images. These half-tone processed images may look to a human eye as low frequency gray scale images expressed well in gray scale, but are actually high frequency screened images. It can be seen that, if the blocks of division areas of FIG. 2 are gathered together, the blocks form a screened image. If the half-tone processed images are scanned by a charged coupled device (CCD), for example, a 600DPI-resolution CCD, or a contact image sensor (CIS), one pixel is discretized into fine pixels of about 42.3 μm each. Accordingly, an area that must be recognized as a photo area is wrongly detected as the text or a fine line.

The screened halftone image is a distortion appearing on data obtained by half-toning a photo area and scanning a half-toned image by regarding the half-toned image as the original document.

When such a screened half-tone pattern appears, a bright pixel, that is, a pixel with brightness equal to or greater than the threshold Th0, intermittently appears, such that an area to be recognized as a photo is highly likely to be wrongly recognized as a character. Accordingly, if a half-toned document is scanned, a half-toned photo area is wrongly recognized as a character. If the wrongly recognized character area is emphasized, an output greatly distorted in reproducibility is obtained.

### SUMMARY OF THE INVENTION

To solve the above and/or other problems, it is an aspect of the present invention to provide an image quality enhancement method in which an image area, a text area, and a non-image area including a background, from a document including a combination of a text and an image, are accurately distinguished from one another, and the distinguished areas are emphasized by different techniques and to different degrees.

Additional objects and advantages of the invention will be set forth in part in the description which follows and, in part, will be obvious from the description, or may be learned by practice of the invention.

According to an aspect of the present invention there is provided an apparatus to perform the image quality enhancement method.

According to an aspect of the present invention there is provided a digital image quality enhancement method, in which, as to image data including pixels with a predetermined resolution, the image data is obtained by scanning a script including a combination of a background, a text, and an image, when a pixel of interest is first classified into one of a text area, a background area, and an image area. Thereafter, the image quality of the pixel of interest is improved to different degrees that depend on which area the pixel of interest is classified. Then, a pixel adjacent to the pixel of interest is set to be a new pixel of interest. The new pixel of interest undergoes the same image quality enhancement as described above. To be more specific, in the digital image quality enhancement method, RGB color data of the pixel of interest is converted into color data having a brightness component and a saturation component. Next, the pixel of interest is classified into one of a background pixel, an image pixel, and a text pixel by using the brightness component and the saturation component. Thereafter, the pixel of interest and a number of successive background pixels or image pixels before the pixel of interest are stored as the history information regarding the pixel of interest. Then, the pixel of interest is labeled as one of the text area, the background area, and the image area by using the stored history information of the pixel of interest. Thereafter, the image quality of the pixel of interest is improved to different degrees depending on the labeled areas. Finally, a determination is made as to whether the pixel of interest is a final pixel whose image quality is to be improved. If it is determined that the pixel of interest is not a final pixel, the method goes back to the RGB color data conversion.

For instance, the digital image quality enhancement method optionally includes performing smoothing to reduce a high frequency component of the brightness component, after the RGB color data conversion.

In accordance with an aspect of the present invention, there is provided a digital image quality enhancement method, the method including: converting RGB color data of a pixel of interest into color data having a brightness component and a saturation component; segmenting the pixel of interest into a background pixel, an image pixel, or a text pixel using the brightness component and the saturation component; labeling the pixel of interest as a text area, a background area, or an image area using history information regarding the pixel of interest, wherein the history information is a number of successive background pixels or image pixels before the pixel of interest; enhancing an image quality of the pixel of interest to degrees corresponding to the area labeled; and determining whether the pixel of interest is a final pixel of which an image quality is to be improved.

According to an aspect of the present invention, there is provided a digital image quality enhancement apparatus including: a classification unit classifying a pixel of interest in image data comprising pixels with a predetermined resolution and obtained by scanning a script comprising a combination of a background, a text, and an image into any of a text area, a background area, and an image area; and an image quality enhancement unit enhancing a quality of an image to different degrees according to an area to which the pixel of interest belongs. In the classification means, a color data conversion unit converts RGB color data of the pixel of interest into brightness/saturation data having a brightness component and a saturation component. A pixel segmentation unit classifies the pixel of interest into any of a background pixel, an image pixel, and a text pixel by using the brightness/saturation data and outputting a result of the classification as a pixel segmentation signal. A history information storage unit counts a number of successive background pixels before the pixel of interest using the pixel segmentation signal and storing the counted number of background pixels as background history information in a predetermined address corresponding to the pixel of interest. Alternatively, the history information storage unit counts a number of successive image pixels before the pixel of interest and storing the counted number of image pixels as image history information in the address corresponding to the pixel of interest. An area segmentation unit receives the background or image history information regarding the pixel of interest from the history information storage unit, classifying the pixel of interest into any of the text area, the background area, and the image area by using the received background or image history information. If the pixel of interest is classified into a text area, the area segmentation unit labels the pixel of interest as the text. If the pixel of interest is classified into the background area, the area segmentation unit labels the pixel of interest as the background. If the pixel of interest is classified into the image area, the area segmentation unit labels the pixel of interest as the image.

According to an aspect of the present invention, the digital image quality enhancement apparatus optionally includes a smoothing unit performing smoothing to reduce a high frequency component of the brightness component of the brightness/saturation data using a low pass filter and outputting new brightness/saturation data having a smoothed brightness component. The pixel segmentation unit classifies the pixel of interest into one of the background pixel, the image pixel, and the text pixel using the new brightness/saturation data and outputting a result of the classification as a pixel segmentation signal.

According to an aspect of the present invention, there is provided a digital image quality enhancement apparatus, including: a color data conversion unit converting RGB color data of a pixel of interest into color data having a brightness component and a saturation component; a pixel segmentation unit segmenting the pixel of interest into a background pixel, an image pixel, or a text pixel using the brightness component and the saturation component; a history information storage unit labeling the pixel of interest as a text area, a background area, or an image area using history information regarding the pixel of interest, wherein the history information is a number of successive background pixels or image pixels before the pixel of interest; an image quality enhancement unit enhancing an image quality of the pixel of interest to degrees corresponding to the area labeled; and an area segmentation unit determining whether the pixel of interest is a final pixel of which an image quality is to be improved.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional image processing system to process a document including a combination of a text and an image by distinguishing the text from the image;

FIG. 2 shows a 2×2 division area and dot configurations to obtain five black/white gray scale steps illustrating an example of half-tone processing;

FIG. 3 is a flowchart illustrating a digital image quality enhancement method, according to an aspect of the present invention;

FIG. 4 shows a 3×3 mask of a low pass filter capable of performing a smoothing step of FIG. 3, in accordance with an aspect of the present invention;

FIG. 5 is a graph illustrating a pixel segmentation step of FIG. 3, in accordance with an aspect of the present invention;

FIG. 6 explains a condition to detect a background feature in an area segmentation step of FIG. 3, in accordance with an aspect of the present invention;

FIG. 7 explains a condition to detect an image feature in the area segmentation step of FIG. 3;

FIG. 8 is a flowchart illustrating the area segmentation step of FIG. 3, in accordance with an aspect of the present invention; and

FIG. 9 is a block diagram of a digital image quality enhancement apparatus, according to an aspect of the present invention.

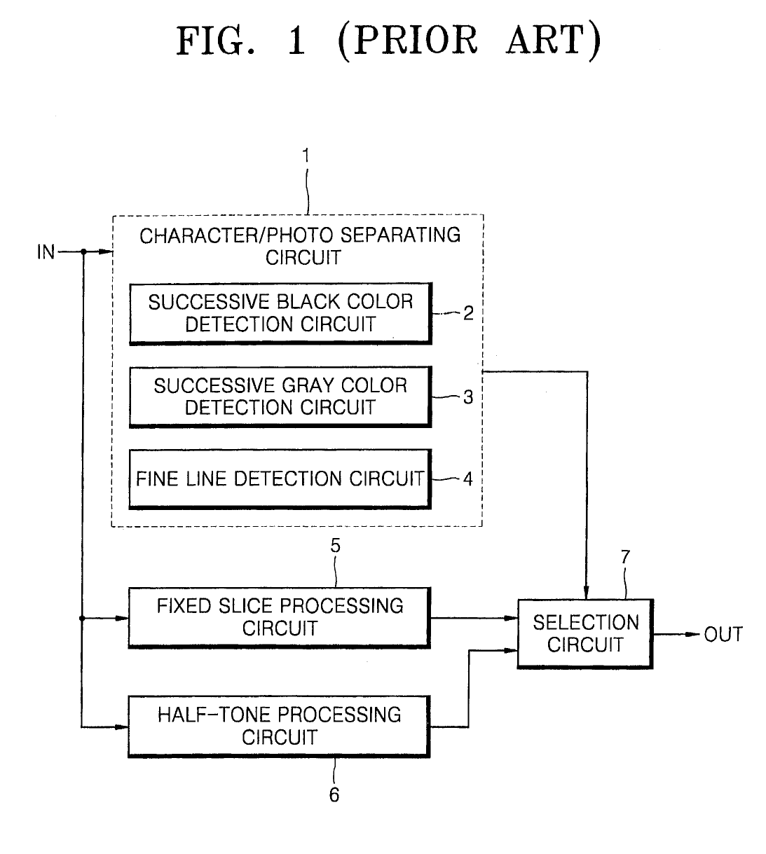

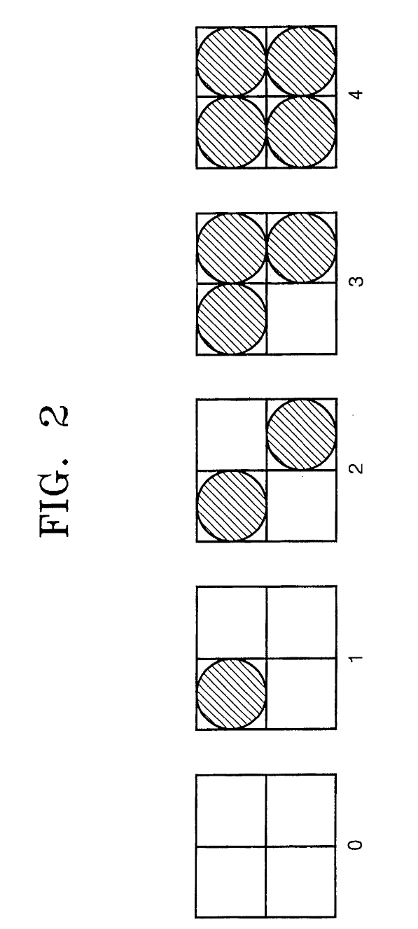

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

In an image quality enhancement method, according to an aspect of the present invention, data obtained by scanning a pixel image with a predetermined resolution through an image input device, such as a scanner, is to be processed.

The scanner includes a light source, a lens, and an image sensor. The light source projects light onto a script including a combination of a background, a text, and an image. The lens converges reflected light. The image sensor receives the converged light. The image sensor, which is implemented as a charge coupled device (CCD) or a contact image sensor (CIS), includes electrical cells spaced at predetermined intervals, and receives the light reflected from the script corresponding to analog image data and discretizes the received light into digital image data with a predetermined resolution. Here, a minimum unit of discretized data is data corresponding to each cell in the image sensor and is referred to as a pixel.

According to an aspect of the present invention, a term “pixel of interest” indicates a pixel on which the image quality enhancement method, according to an aspect of the present invention, is performed. A term “line of interest” denotes a row to which the pixel of interest belongs. Upper side, lower side, right side, and left side pixels are determined based on the pixel of interest. A term “left side pixel” denotes a pixel that exists on the line of interest and is processed before the pixel of interest. A term “right side pixel” denotes a pixel that exists on the line of interest and is processed after the pixel of interest. A term “upper side pixel” denotes a pixel that exists on a line processed immediately before the line of interest and is adjacent to the pixel of interest. A term “lower side pixel” denotes a pixel that exists on a line next to an already-processed line and is adjacent to the pixel of interest.

According to an aspect of the present invention, an image quality enhancement method is provided in which, as to the image data that includes pixels with a predetermined resolution and obtained by scanning the script including the combination of the background, the text, and the image, the pixel of interest is assigned to a corresponding area among a character area, a background area, and a photo area. An image quality of the pixel of interest is improved to a degree corresponding to the assigned area. Further, the pixel next to the pixel of interest on which the image quality enhancement process has been performed is set as a new pixel of interest, and the new pixel of interest also undergoes the above-described image quality enhancement process.

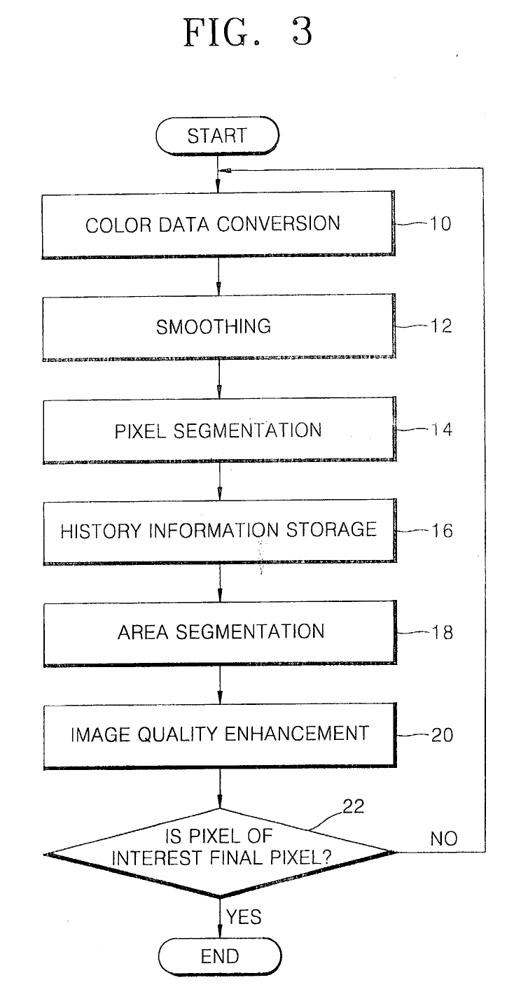

FIG. 3 is a flowchart illustrating the image quality enhancement method, according to an aspect of the present invention, which includes a color data conversion 10, data smoothing 12, a pixel segmentation 14, a history information storage 16, an area segmentation 18, an image quality enhancement 20, and a determination 22 of whether the pixel of interest is a final pixel 22.

To be more specific, in the color data conversion 10, RGB color data of the pixel of interest is converted into color data that has a brightness component and a saturation component.

Models expressing colors are expressed in a three-dimensional coordinate system, and are mostly used by color monitors, color printers, animation graphics, or TV images. The color models include a red/green/blue (RGB) model for the color monitors or color video cameras, a YIQ color model, which is a standard for color TV broadcasting, a YcbCr color model, and the like.

The RGB color model originates from a manner in which the image sensor of the camera or the scanner and a light emitting display operate. In order to process a color image with a 256 gray scale, 8 bits are allocated for each of the R, G, and B in the pixel, and consequently, one pixel requires a storage space of 24 bits, that is, 3 bytes.

The YIQ color model is adopted to achieve compatibility with equipment for color TV broadcasting. The YIQ color model divides RGB color data into the brightness component and the saturation component. A Y component representing the brightness provides all kinds of video information required by black and white TVs. I and Q components representing saturation indicate an inphase and a quadrature, respectively. The conversion of color data from the RGB color model to the YIQ color model is made by Equation 1:

Y=0.29900R+0.58700G+0.11400B

I=0.59600R−0.27500G−0.32100B (1)

Q=0.21200R−0.52300G+0.31100B

The YCbCr color model has been proposed by the International Telecommunication Union-Radio communication sector (ITU-R) BT.601 in order to establish digital video components. YCbCr is another color space that separates the brightness from color information. The brightness is symbolized as Y, and blue information and red information are symbolized as Cb and Cr, respectively. Among many methods of converting the YCbCr color model into the RGB color model and vice versa, the ITU-R recommends a typical color data conversion method used for image compression, such as JPEG or MPEG, the conversion method being expressed as in Equation 2:

Y=0.29900R+0.58700G+0.11400B

Cb=−0.16874R−0.33126G+0.50000B

Cr=0.50000R−0.41869G−0.08131B

R=1.00000Y+1.40200Cr

G=1.00000Y−0.34414Cb−0.71414Cr

B=1.00000Y+1.77200Cb tm (2)

According to an aspect of the color data conversion 10, if color data is converted using the YCbCr color model, the Y component is adopted as the brightness component, and the saturation component can be obtained using the Cb and Cr components. For example, the saturation component can be obtained from a sum of an absolute value of Cb and an absolute value of Cr. Alternatively, the saturation component can be obtained from a root mean square (RMS) of Cb and Cr. The two cases are expressed in Equations 3 and 4, respectively:

Saturation=|Cb|+|Cr| (3)

Saturation=\sqrt{Cb²+Cr²} (4)

In the image quality enhancement method, according to an aspect of the present invention, the data smoothing 12 can be selectively performed after the color data conversion 10, so that the pixel segmentation 14 can perform more precise pixel segmentation. In the data smoothing 12, smoothing is performed to reduce a high frequency component in the brightness component.

FIG. 4 shows a 3×3 mask of a low pass filter capable of performing the data smoothing 12 of FIG. 3. In an aspect of the data smoothing 12, a low pass filter of a predetermined pixel block size, for example, 3×3 blocks, performs smoothing. The filter denotes a spatial filter and is also referred to as a mask. As to a screened half-tone area obtained when an original half-toned image is scanned, an error occurs when a photo area in the screened half-tone area is segmented. An emphasis of a wrongly-segmented photo area may produce an output where a noise component has been distorted. The low pass filter converts the screened half-tone area into an area with a tone similar to a continuous tone, so that the error generated when the image area is segmented in the area segmentation 18 can be reduced. As can be seen from FIG. 4, when the pixel at a center of the mask is the pixel of interest, brightness values of pixels existing in the mask are added to the mask, and accordingly, a response processed by the low pass filter is simply a mean of all of the pixels existing within the mask. Smoothing by the low pass filter is an image processing technique used in pre-treatment, such as, removal of a small, fine portion from the image before extraction of a large object from the image, connection of lines to small cracks within curved lines, or noise removal. The block size of the low pass filter used in the data smoothing 12 is not necessarily 3×3. A larger mask block can reduce an output distortion due to the screened half-tone area, but degrades a sharpness of an image quality by over-suppressing a high frequency component. Accordingly, the size of the mask block is appropriately determined depending on the resolution and output specification of the scanner.

In the pixel segmentation 14 for pixel segmentation, the pixel of interest is classified into a background pixel, an image pixel, or a text pixel by using the brightness component and saturation component obtained through the color data conversion 10 and selectively including the smoothing 12.

According to an aspect of the present invention, in the pixel segmentation 14, the pixel of interest is segmented as the background pixel, the image pixel, or the text pixel, using a predetermined brightness threshold and a predetermined saturation threshold for the brightness and saturation components, respectively, obtained through the color data conversion 10. For instance, the pixel of interest is segmented as the background pixel, the image pixel, or the text pixel, using a predetermined high brightness threshold Th0 and a predetermined low brightness threshold Th1.

An example of a segmentation result is shown in FIG. 5. To be more specific, if the brightness component of the pixel of interest is greater than the high brightness threshold Th0 and the saturation component is smaller than the saturation threshold S0, the pixel of interest is segmented as the background pixel. A pixel f of FIG. 5 corresponds to the background pixel. If the brightness component of the pixel of interest is greater than the low brightness threshold Th1 or the saturation component of the pixel of interest is greater than the saturation threshold S0 while the pixel of interest is not segmented as the background pixel, the pixel of interest is segmented as the image pixel. In other words, if the brightness component of the pixel of interest is smaller than Th0 and greater than Th1 or the saturation component of the pixel of interest is greater than S0, the pixel of interest is segmented as the image pixel. Pixels a, b, c, and e of FIG. 5 correspond to image pixels. If the pixel of interest is segmented as neither the background pixel nor the image pixel, the pixel of interest is segmented as the text pixel. Pixel d of FIG. 5 corresponds to the text pixel.

In the history information storage 16, which is the pre-processing of the area segmentation 18, the number of successive pixels of similar types, which is used in the area segmentation 18 to serve as a condition to detect a background feature and an image feature, is stored as background history information or image pixel history information. In the history information storage 16, using the background pixel history information or the image pixel history information, which are obtained by processing the previous pixel and the result of pixel segmentation in the pixel segmentation 14, the number of background pixels, image pixels, and non-image pixels continuing in an upper direction or a left direction of the pixel of interest is updated and stored.

According to an aspect of the present invention, in the history information storage 16 storing the background history information when the pixel of interest is segmented as a background pixel in the pixel segmentation 14, the number of background pixels continuing before and in the upper direction of the pixel of interest, including the pixel of interest, is stored as information of the pixel of interest. For instance, if the number of background pixels continuing in the upper direction of the pixel of interest, including the pixel of interest, is equal to or greater than a predetermined number p, the number p is stored as the image history information of the pixel of interest. To be more specific, the number p can be set to be 10 at a 600 dpi (dot per inch) resolution.

According to another aspect of the present invention, in the history information storage 16 storing the image history information, when a pixel of interest is segmented as a non-background pixel in the pixel segmentation 14, the number of non-background pixels continuing in the left direction of the pixel of interest including the pixel of interest is stored as the image history information of the pixel of interest. For instance, if the number of non-background pixels continuing in the left direction of the pixel of interest including the pixel of interest is equal to or greater than a predetermined number r, the number r is stored as the image history information of the pixel of interest. To be more specific, the number r can be set to be 200 at the 600 dpi resolution.

In the area segmentation 18 for area segmentation, the pixel of interest is labeled so as to belong to one of the text area, a background area, and the image area, using the history information on the pixel of interest stored in the history information storage 16.

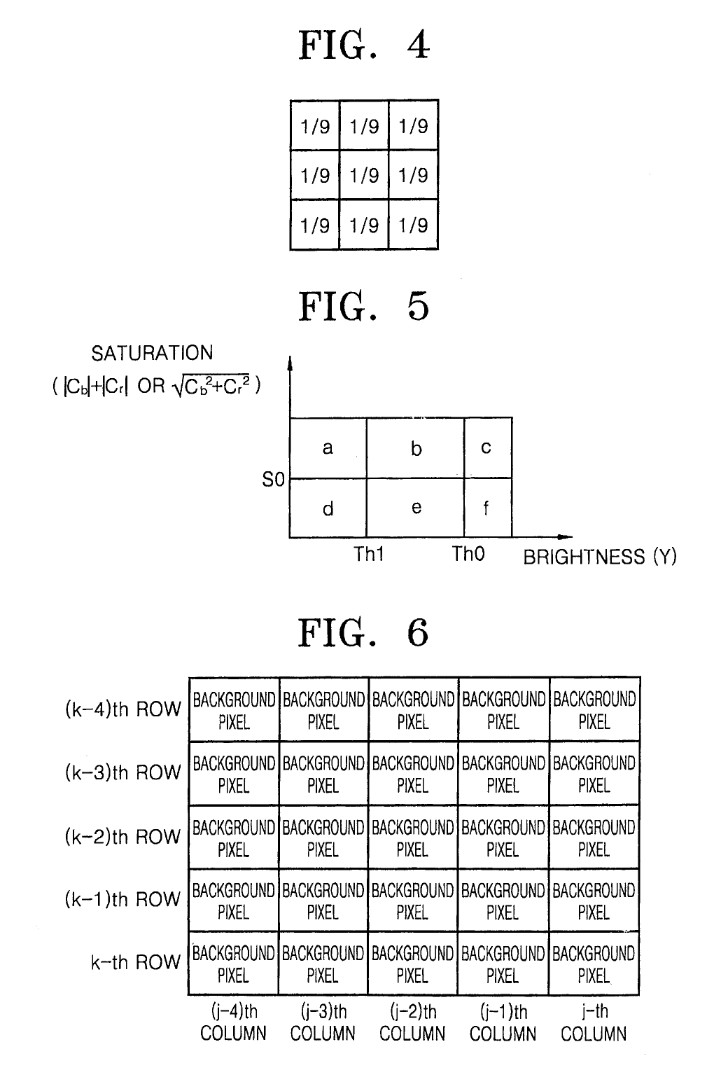

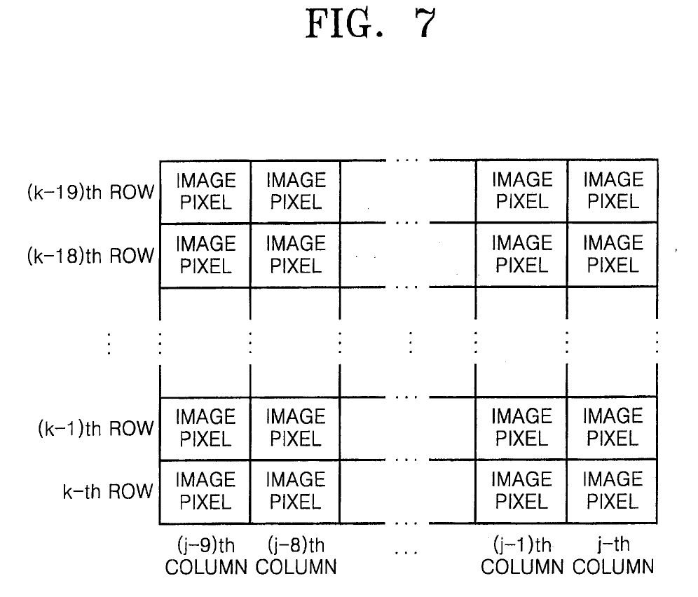

FIG. 6 explains a condition of detecting the background feature in the area segmentation 18 of FIG. 3, and FIG. 7 explains a condition of detecting the image feature in the area segmentation 18 of FIG. 3.

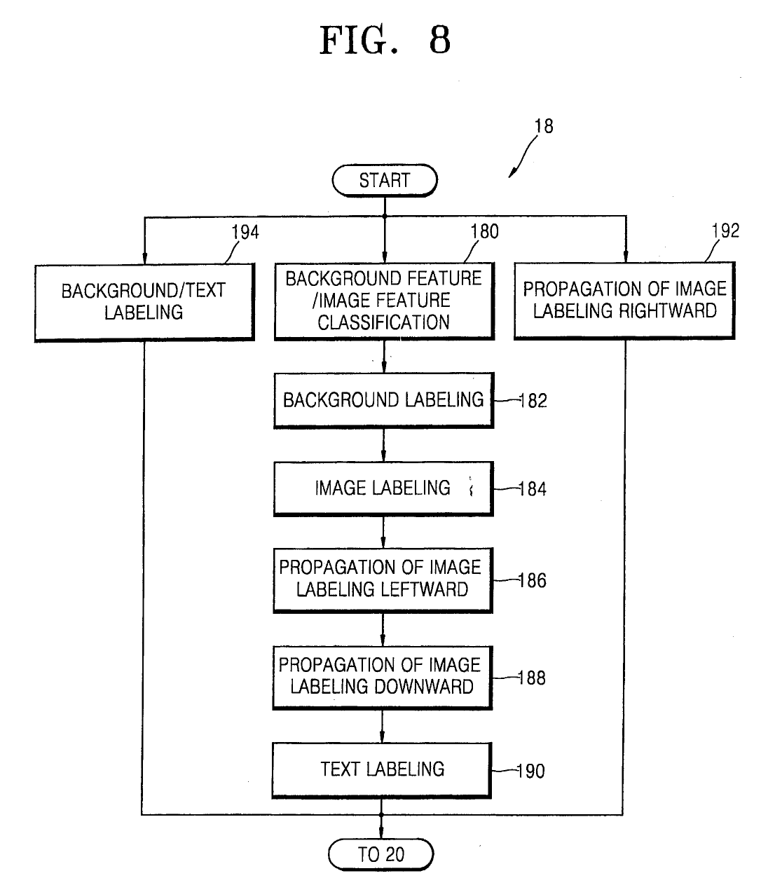

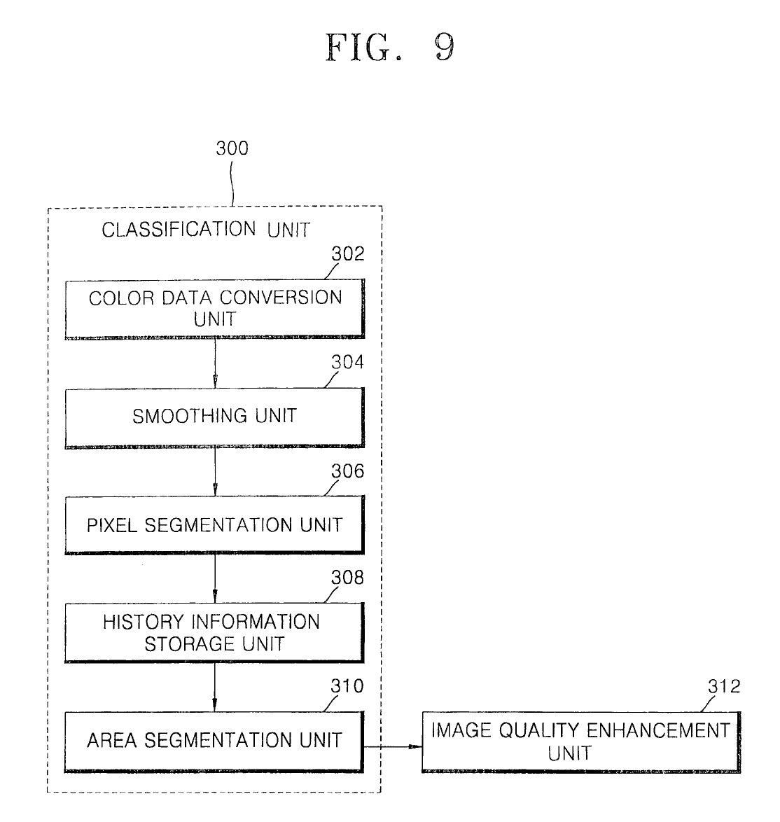

FIG. 8 is a flowchart illustrating an aspect of the area segmentation 18 of FIG. 3. The area segmentation 18 includes a background feature/image feature classification 180, a background labeling 182, and an image labeling 184. The area segmentation 18 optionally includes an image area propagation 186 through 190, a text labeling 192, and a background/text labeling 194.

In the background feature/image feature classification 180, using the history information on the pixel of interest stored in the history information storage 16, the pixel of interest is classified into either the background feature pixel connected to consecutive background pixels or the image feature pixel connected to consecutive image pixels. In accordance with an aspect of the present invention, in the background feature/image feature classification 180 for background feature pixel classification, if there are n pixels, each of the pixels in which the size of background history information is a predetermined number m or greater and exist in succession on the left side of the pixel of interest. The pixel of interest is classified into the background feature pixel. To be more specific, m and n can be set to be 5 at the 600 dpi resolution.

In accordance with an aspect of the present invention, the background feature/image feature classification 180 for image feature pixel classification, if q pixels, each of the pixels in which the size of image history information is a predetermined number p or greater, exist in succession on the left side of the pixel of interest, the pixel of interest is classified into the image feature pixel. To be more specific, p and q can be set to be 10 and 20, respectively, at the 600 dpi resolution. In another aspect of the present invention of the background feature/image feature classification 180, if the size of the image history information on the pixels that exist in succession on the left side of the pixel of interest is a predetermined number n or greater, the pixel of interest is classified into the image feature pixel. To be more specific, r can be set to be 200 at the 600 dpi resolution.

An aspect of a process of detecting the background feature/image feature using history information will now be described referring to FIGS. 6 and 7.

In the area segmentation 18, the pixel of interest can be detected as the background feature if all the pixels within an m×n block are the background pixels. For example, m and n can be set to be 5 at the 600 dpi resolution. As shown in FIG. 6, if 5 background pixels, including the background pixel into which the pixel of interest (k, j) has been classified, continue on the left side of the pixel of interest and the 5 background pixel columns continue in five rows, the pixel of interest (k, j) is detected as the background feature pixel. According to an aspect of a method of detecting a background feature from a 5×5 pixel block, it can be detected whether 5 background pixels columns including the pixel of interest continue in at least 5 columns. If the pixel of interest (k, j) is determined as the background pixel in the smoothing 12, each of the pixels (k−4, j−4) through (k, j−4) on the left side of the pixel of interest (k, j) having the background history information stores the background history information, and the pixel columns (k−4, j) through (k, j) are all the background pixels, the pixel (k, j) is detected as the background feature pixel.

In the area segmentation 18, the pixel of interest can be detected as having the image feature if the pixels within a p×q pixel block, for example, the pixels within a 10×20 block at the 600 dpi resolution are all image pixels or at least a predetermined number of non-background pixels, for example, 200 pixels or more at the 600 dpi resolution continue on a line of interest.

Whether the pixel of interest is detected as the background feature is not determined by checking the data on whether the pixels within the above-defined m×n block have the black and white scale image or the color scale image, but by checking information on how many background pixels continue in the upper direction of the pixel of interest and whether the pixels continue in 5 or more columns and rows. That is, the pixels before the pixel of interest do not need the data relating to the scale image but need only information on how many background pixels continue. Thus, a memory used by the background pixel in order to store the background history information is {log₂m+1} bits. Here, { } denotes a Gauss symbol. If m is 5, one background pixel requires 3 (=log₂5+1) bits in order to update the stored background history information.

An aspect in which the background history information on the pixel of interest (k, j) is stored in the history information storage 16 will now be described with reference to FIG. 6. As described above, a 3-bit storage space is allocated to each background pixel in order to update the stored history information. When the background pixel first appears at the pixel (k−4, j−4) in the pixel segmentation 14, if the pixels (k−4, j−4) through (k, j−4) are all the background pixels, the stored history information is updated with binary numbers 001, 010, 011, 100, and 101, which are the information of the pixels (k−4, j−4) through (k, j−4), respectively, and the binary numbers are stored. Likewise, the information on the background pixels (k, j−3) through (k, j) is updated with the binary number 101, and the updated information is stored. If a pixel (k+1, j−4) on the line next to the line of interest is the background pixel, the binary number 101 is re-stored. If the pixel (k+1, j−4) is not the background pixel, a binary number 000 is stored.

Similarly, {log₂p+1} bits are required with respect to the image feature. If p is 10, each image pixel requires 4 (=log₂10+1) bits in order to update the information. If the image pixel first appears at the pixel (k−9, j−19) and the pixels (k−9, j−19) through (k, j−19) are all image pixels, information pieces on the image pixels are updated with binary numbers 0001 through 1010, respectively, and the new information pieces are stored.

In a conventional image processing method not including the history information storage 16, 8 bits are allocated to each of R, G, and B in the pixel in order to segment an area for the color image with a 256 scale. Consequently, each pixel requires a 24-bit storage space, that is, a 3-byte storage space. In order to process the 256-scale image, an existing gray-scale or the color image requires 8 black-and-white bits or 24 RGB color bits, respectively. Meanwhile, the image processing method, according to an aspect of the present invention, includes a history information updating step, such that only 7 bits are required to achieve the area segmentation. Accordingly, when an application specific integrated circuit (ASIC) adopting the image quality enhancement method, according to an aspect of the present invention, is used as the image quality enhancement apparatus, the amount of memory used is significantly reduced, thus limiting manufacturing costs.

Referring back to FIG. 8, in the background labeling 182, the pixel of interest classified into the background feature pixel in the background feature/image feature classification 180 is labeled as the background so as to belong to the background area.

In the image labeling 184, the pixel of interest classified into the image feature pixel in the background feature/image feature classification 180 is labeled as the image so as to belong to the image area.

In FIG. 8, according to an aspect of the present invention, the background feature/image feature classification 18 further includes propagating the image area 186, that is, propagating the image area in the left direction, propagating an image area in the right direction 192, and propagating the image area in the lower direction 188.

In the propagation of the image area in the left direction 186, if the pixel of interest on the line of interest has been classified into an image feature pixel in the background feature/image feature classification 180, successive pixels that contributed to classifying the pixel of interest into the image feature pixel and that exist on the left side of the pixel of interest are labeled as the image areas, and the image areas are propagated to left-side pixels on the line of interest.

In the propagation of the image area in the lower direction 188, if the pixel of interest on the line of interest has been classified into neither the background feature pixel nor the image feature pixel in the background feature/image feature classification 180, the pixel above the pixel of interest and on the line before the pixel of interest is labeled as the image area, and the image area is propagated to a pixel on the lower side of the pixel of interest.

In text labeling 190, which is optional when performing the area segmentation 18, when the pixel of interest has been classified into neither the background feature pixel nor the image feature pixel in the background feature/image feature classification 180, if the pixels above the pixel of interest, that is, existing on the previous line of the line of interest, have not been labeled as the image areas, the pixel of interest is labeled as the text area. In other words, in the text labeling 190, if the pixel of interest is neither the background feature pixel nor the image feature pixel and is not propagated to an image area, the pixel of interest is labeled as the text.

In the propagation of the image in the right direction 192, if the pixel of interest on the line of interest is labeled as the image 184, all of the right-side pixels existing between the pixel on the right side of the pixel of interest and the pixel before the background feature pixel, are labeled as the image area, and the image area is propagated to the right side of the pixel of interest on the line of interest.

In a background/text labeling 194, which is optional in the area segmentation 18, when the adjacent pixel on the left side of the pixel of interest on the line of interest has been labeled as the background area, if the pixel of interest is the background pixel, the pixel of interest is labeled as the background area. On the other hand, if the pixel of interest is not the background pixel, the pixel of interest is labeled as the text area.

Referring back to FIG. 3, in the image quality enhancement 20, the quality of the image is improved to different enhancement degrees according to whether the pixel of interest has been labeled as the text area, the background area, or the image area in the history information storage 16. In an exemplary aspect of the present invention, the image quality enhancement 20 includes a text enhancement 200 and an image enhancement 210.

In a text enhancement 200, the image quality of the pixel of interest labeled as the text area in the area segmentations 18 is improved differently according to brightness. For instance, the brightness of the pixel of interest is classified into three brightness classes that are determined based on two predetermined brightness thresholds. Among the three brightness classes, the brightest pixel is completely filled with the white color. When the color 256-scale image is output, R is indicated by 255, G is indicated by 255, and B is indicated by 255. The darkest pixel is completely filled with the black color and designates R, G, and B to be 0. A pixel with the middle brightness is sharpened. An unsharpened masking can be adopted to sharpen the middle bright pixel. For instance, the unsharpened masking is performed by increasing an emphasis coefficient to no less than a predetermined value in order to increase an edge emphasis effect.

The unsharpened masking will now be described in more detail. A high pass is obtained by calculating a difference between the pixel of interest (X) and a low pass \overline{X} of the pixel of interest as in Equation 5:

high pass=X−\overline{X} (5)

The unsharpened masking denotes a general process of subtracting a blurred image from an original image. A greater emphasis coefficient causes an increased edge emphasis effect. An aspect of a result of the unsharpened masking process is obtained as in Equation 6:

X′=X+k·(X−\overline{X}) (6)

wherein X denotes a central pixel, \overline{X} denotes a mean pixel, k denotes an emphasis coefficient, and X′ denotes the result of the unsharpened masking process. That is, the result of the unsharpened masking process is obtained by adding the high pass weighted with a predetermined emphasis coefficient to the original image of the pixel of interest.

Another embodiment of the unsharpened masking is performed as in Equation 7, as presented in “Digital Image Processing” by Gonzalez & Woods:

X′=A·X−\overline{X}=(A−1)·X+(X−\overline{X}) (7)

wherein X denotes a center pixel, \overline{X} denotes a mean pixel, A denotes a magnification factor, and X′ denotes the result of the unsharpened masking process.

Such unsharpened masking causes a severe distortion in a screened half-tone area that frequently occurs when the printed image is copied, because a half-toned image is actually shown as a high frequency pattern although the half-toned image is a low frequency portion to the human eye, that is, the half toned image is shown at a resolution range that can be identified by the human eye. As a result, a screened area, which is an image area not needed to be emphasized, is severely emphasized because of the charactristics of sharpening in which a high frequency pattern is greatly emphasized, such that an undesired emphasis effect is created.

In an image enhancement 20, the image quality of the pixel of interest labeled as the image area in the area segmentation 18 is improved by sharpening the pixel of interest, for instance, using an unsharpened masking process. In the unsharpened masking process for the image area, an emphasis coefficient may be set to be no more than a predetermined value and then processed in order to prevent a screened halftone area from being distorted when the emphasis coefficient is set to be high as described above. Because the distortion of the screened half-tone area is partially reduced by further including the data smoothing 12 to smooth the screened half-tone pattern before the pixel segmentation 14 is performed, the value of the emphasis coefficient can be appropriately adjusted according to whether the data smoothing 12 and the image quality enhancement specification are included. That is, because the distortion of a screened half-tone area can be reduced when the data smoothing 12 is further included, the emphasis coefficient can be determined to be greater.

Next, it is determined whether the pixel of interest is the final pixel 22 whose image quality is to be improved. If it is determined that the pixel of interest is not the final pixel, the method goes back to the color data conversion 10. Above-described color conversion 10 through the image quality enhancement 20 correspond to a process of enhancement the image quality based on one pixel of interest. Accordingly, the determination of whether the pixel of interest is the final pixeL 22 is provided to perform the image quality enhancement based on the pixel of interest, set the adjacent pixel as a new pixel of interest, and perform the image quality enhancement on the new pixel of interest.

FIG. 9 is a block diagram of a digital image quality enhancement apparatus according to an aspect of the present invention. The apparatus includes a classification unit 300 and an image quality enhancement unit 312. The classification unit 300 includes a color data conversion unit 302, a pixel segmentation unit 306, a history information storage unit 308, and an area segmentation unit 310.

The classification unit 300 classifies the pixel of interest in the image data composed of pixels with a predetermined resolution, the image data obtained by scanning the script including the combination of the background, the text, and the image, into the text area, the background area, or the image area.

The color data conversion unit 302 converts the RGB color data of the pixel of interest into brightness/saturation data having the brightness component and the saturation component.

The pixel segmentation unit 306 classifies the pixel of interest into the background pixel, the image pixel, or the text pixel using the brightness/saturation data and outputs a pixel segmentation signal.

The history information storage unit 308 counts the number of successive background pixels before the pixel of interest by using the pixel segmentation signal and stores the counted number of pixels as background history information in an address corresponding to the pixel of interest. Alternatively, the history information storage unit 308 counts the number of successive image pixels before the pixel of interest by using the pixel segmentation signal and stores the counted number of pixels as the image history information in the address corresponding to the pixel of interest.

The area segmentation unit 310 receives the background or image history information associated with the pixel of interest from the history information storage unit 308, and classifies the pixel of interest into the text area, the background area, or the image area. If the pixel of interest is classified into the text area, the area segmentation unit 310 labels the pixel of interest as the text area. If the pixel of interest is classified into the background area, the area segmentation unit 310 labels the pixel of interest as the background area. If the pixel of interest is classified into the image area, the area segmentation unit 310 labels the pixel of interest as the image area.

The image quality enhancement unit 312 receives the text labeling signal, the background labeling signal, or the image labeling signal from the area segmentation unit 312 and improves the image quality by applying different degrees to classified areas. For instance, the image quality enhancement unit 312 improves the quality of an image by classifying the brightness/saturation data of the text-labeled pixel of interest into at least two classes based on a predetermined brightness threshold. The image quality enhancement unit 312 improves the image quality of the image-labeled pixel of interest using an unsharpened mask.

The smoothing unit 304 is optional in the image quality enhancement apparatus, according to an aspect of the present invention, which performs smoothing to decrease the high frequency component of the brightness component of the brightness/saturation data using a low pass filter, and outputs new brightness/saturation data including the smoothed brightness component. Next, the pixel segmentation unit 306 classifies the pixel of interest into the background pixel, the image pixel, or the text pixel using the new brightness/saturation data output from the smoothing unit 304 and outputs the result of the classification as the pixel segmentation signal.

As described above, in a digital image quality enhancement method and apparatus, according to an aspect the present invention, an image including a combination of text and image is accurately divided into areas by using history information that represents a tendency that pixels of the same type continue. In particular, a utilization of smoothing and a smoothing unit on pixel segmentation reduce an image area segmentation error due to a screened half tone. Propagation of an image area in left, right, and lower directions prevents emphasis of noise, which can be abruptly generated in the image area, or excessive emphasis of a text included in an image. Because an emphasis method and an emphasis degree are each subdivided according to a classified area, a good quality of output can be obtained. The use of history information reduces an amount of memory used for area segmentation, thus reducing manufacturing cost.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A digital image quality enhancement method where image data comprising pixels with a predetermined resolution is obtained by scanning a script comprising a combination of a background, a text, and an image, the method comprising:
converting RGB color data of a pixel of interest into color data having a brightness component and a saturation component;
classifying the pixel of interest into any of a background pixel, an image pixel, and a text pixel using the brightness component and the saturation component;
storing a number of successive background pixels or image pixels before the pixel of interest and the pixel of interest, as history information regarding the pixel of interest;
labeling the pixel of interest as any of a text area, a background area, and an image area using the history information regarding the pixel of interest;
enhancing an image quality of the pixel of interest to different degrees depending on the area labeled; and
determining whether the pixel of interest is a final pixel of which the image quality is to be improved.

2. The digital image quality enhancement method of claim 1, wherein, in the conversion of the RGB color data, the RGB color data is converted into YCbCr color data, where a Y component is adopted as the brightness component, and the saturation component is obtained from Cb and Cr components.

3. The digital image quality enhancement method of claim 2, wherein the saturation component is a sum of absolute values of the Cb and Cr components.

4. The digital image quality enhancement method of claim 2, wherein the saturation component is a root mean square (RMS) of the Cb and Cr components.

5. The digital image quality enhancement method of claim 1, wherein the pixel of interest is classified into any of the background pixel, the image pixel, and the text pixel by using one of a predetermined brightness threshold for the brightness component and a predetermined saturation threshold for the saturation component.

6. The digital image quality enhancement method of claim 5, wherein the pixel of interest is classified into any of the background pixel, the image pixel, and the text pixel by using one of a high brightness threshold and a low brightness threshold as the predetermined brightness threshold.

7. The digital image quality enhancement method of claim 6, wherein when the brightness component of the pixel of interest is greater than the high brightness threshold and the saturation component is smaller than the saturation threshold, the pixel of interest is classified into the background pixel.

8. The digital image quality enhancement method of claim 7, wherein when the brightness component of the pixel of interest is greater than the high brightness threshold or the saturation component is greater than the saturation threshold, the pixel of interest is classified into the image pixel.

9. The digital image quality enhancement method of claim 8, wherein when the pixel of interest is classified into neither the background pixel nor the image pixel, the pixel of interest is classified into the text pixel.

10. The digital image quality enhancement method of claim 1, further comprising:
performing smoothing to reduce a high frequency component of the brightness component.

11. The digital image quality enhancement method of claim 1, wherein when the pixel of interest is classified as the background pixel, the pixel of interest and the number of successive background pixels that continue in the upper direction of the pixel of interest are stored as a background history information of the pixel of interest.

12. The digital image quality enhancement method of claim 11, wherein when the pixel of interest is classified as the background pixel and the pixel of interest and the number of successive background pixels that continue in the upper direction of the pixel of interest are a predetermined number of m or greater, the number m is stored as the background history information of the pixel of interest.

13. The digital image quality enhancement method of claim 1, wherein when the pixel of interest is classified as the image pixel, the pixel of interest and the number of successive image pixels that continue in an upper direction of the pixel of interest are stored as an image history information of the pixel of interest.

14. The digital image quality enhancement method of claim 13, wherein when the pixel of interest is classified as the image pixel and the pixel of interest and the number of image pixels that continue in the upper direction of the pixel of interest are a predetermined number of p or greater, the number p is stored as the image history information of the pixel of interest.

15. The digital image quality enhancement method of claim 1, wherein when the pixel of interest is classified as a non-background pixel, the pixel of interest and a number of non-background pixels that continue in a left direction of the pixel of interest are stored as an image history information of the pixel of interest.

16. The digital image quality enhancement method of claim 15, wherein when the pixel of interest is classified as the non-background pixel and the number of non-background pixels and the pixel of interest that continue in the left direction of the pixel of interest are a predetermined number of r or greater, the number r is stored as the image history information of the pixel of interest.

17. The digital image quality enhancement method of claim 1, wherein the labeling of the pixel of interest comprises:
classifying the pixel of interest into any of a background feature pixel connected to the successive background pixels and an image feature pixel connected to the successive image pixels by using the history information stored regarding the pixel of interest;
background-labeling the pixel of interest classified into the background feature pixel where the pixel of interest belongs to the background area; and
image-labeling the pixel of interest classified into the image feature pixel where the pixel of interest belongs to the image area.

18. The digital image quality enhancement method of claim 17, wherein, when the pixel of interest on the line of interest is classified into the image feature pixel the labeling of the pixel of interest further comprises:
propagating image labeling leftward of the pixel of interest where consecutive pixels before the pixel of interest, based on the pixel of interest being classified into the image feature pixel, belong to the image area.

19. The digital image quality enhancement method of claim 17, wherein, when the pixel of interest is classified into neither the background feature pixel nor the image feature pixel and a pixel directly above the pixel of interest on a line of interest is image-labeled, the labeling of the pixel of interest further comprises:
propagating image labeling downward the pixel above the pixel of interest where the pixel of interest belongs to the image area.

20. The digital image quality enhancement method of claim 19, wherein when the pixel of interest is classified into neither the background feature pixel nor the image feature pixel, and the pixel directly above the pixel of interest is not image-labeled, the labeling of the pixel interest further comprises:
text-labeling the pixel of interest where the pixel of interest belongs to the text area.

21. The digital image quality enhancement method of claim 17, wherein, when the pixel of interest is classified into the image feature pixel, the labeling of the pixel of interest further comprises: propagating image labeling rightward of the pixel of interest where all of the pixels that exist after the pixel of interest and before the background feature pixel belong to the image area.

22. The digital image quality enhancement method of claim 17, wherein, when a pixel before the pixel of interest on the line of interest is background-labeled, the labeling of the pixel of interest further comprises: background-labeling the pixel of interest when the pixel of interest belongs to the background area, and the pixel of interest is the background pixel, and text-labeling the pixel of interest when the pixel of interest belongs to the text area, and the pixel of interest is not the background pixel.

23. The digital image quality enhancement method of claim 17, wherein when a predetermined number, n, of pixels, which comprise each of the pixels in which a size of the background history information is a predetermined number m or greater, continue in a left direction of the pixel of interest, the pixel of interest is classified into the background feature pixel.

24. The digital image quality enhancement method of claim 17, wherein when a predetermined number, q, of pixels, which comprise each of the pixels in which a size of the image history information is a predetermined number p or greater, continue in a left direction of the pixel of interest, the pixel of interest is classified into the image feature pixel.

25. The digital image quality enhancement method of claim 17, wherein when the pixel of interest has the image history information with a size being a predetermined number r or greater and r or more pixels not classified into background pixels exist on a left side of the pixel of interest, the pixel of interest is classified into the image feature pixel.

26. The digital image quality enhancement method of claim 1, wherein, in the enhancement of the image quality, different image quality enhancements are applied according to a brightness of the pixel of interest designated as the text area.

27. The digital image quality enhancement method of claim 26, wherein the enhancement of the image quality comprises classifying the brightness of the pixel of interest into three brightness groups based on brightness thresholds, processing a brightest pixel to be complete white, processing a darkest pixel to be complete black, and sharpening a middle bright pixel.

28. The digital image quality enhancement method of claim 27, wherein unsharpened masking is performed by determining an emphasis coefficient to be at least a predetermined value to increase an edge emphasis effect.

29. The digital image quality enhancement method of claim 1, wherein the enhancement of the image quality comprises unsharpened masking with respect to the pixel of interest designated as the image area.

30. The digital image quality enhancement method of claim 29, wherein the unsharpened masking is performed by determining an emphasis coefficient to be a predetermined value or less.

31. A digital image quality enhancement method, the method comprising:
converting RGB color data of a pixel of interest into color data having a brightness component and a saturation component;
segmenting the pixel of interest into a background pixel, an image pixel, or a text pixel using the brightness component and the saturation component;
labeling the pixel of interest as a text area, a background area, or an image area using history information regarding the pixel of interest, wherein the history information is a number of successive background pixels or image pixels before the pixel of interest;
enhancing an image quality of the pixel of interest to degrees corresponding to the area labeled; and
determining whether the pixel of interest is a final pixel of which an image quality is to be improved.

32. The digital image quality enhancement method of claim 31, further comprising:
smoothing the color data to reduce a high frequency component in the brightness component.

33. The digital image quality enhancement method of claim 31, wherein the pixel of interest is segmented as the background pixel, the image pixel, or the text pixel using a predetermined high brightness threshold and a predetermined low brightness threshold.

34. The digital image quality enhancement method of claim 31, wherein when the brightness component of the pixel of interest is greater than the high brightness threshold and the saturation component is smaller than a saturation threshold, the pixel of interest is segmented as the background pixel.

35. The digital image quality enhancement method of claim 31, wherein when the brightness component of the pixel of interest is greater than the low brightness threshold or the saturation component of the pixel of interest is greater than the saturation threshold while the pixel of interest is not segmented as the background pixel, the pixel of interest is segmented as the image pixel.

36. The digital image quality enhancement method of claim 31, wherein when the brightness component of the pixel of interest is smaller than the low brightness threshold or greater than the high brightness threshold or the saturation component of the pixel of interest is greater than the saturation threshold, the pixel of interest is segmented as the image pixel.

37. The digital image quality enhancement method of claim 31, wherein when the pixel of interest is segmented as neither the background pixel nor the image pixel, the pixel of interest is segmented as the text pixel.

38. The digital image quality enhancement method of claim 31, wherein, in the conversion of the RGB color data, the RGB color data is converted into YCbCr color data, where a Y component is adopted as the brightness component, and the saturation component is obtained from Cb and Cr components.

39. The digital image quality enhancement method of claim 31, wherein when the pixel of interest is classified as the background pixel, the pixel of interest and the number of successive background pixels that continue in the upper direction of the pixel of interest are stored as a background history information of the pixel of interest.

40. The digital image quality enhancement method of claim 39, wherein when the pixel of interest is classified as the background pixel and the number of successive background pixels that continue in the upper direction of the pixel of interest are a predetermined number of m or greater, the number m is stored as the background history information of the pixel of interest.

41. The digital image quality enhancement method of claim 31, wherein when the pixel of interest is classified as the image pixel, the pixel of interest and the number of successive image pixels and that continue in an upper direction of the pixel of interest are stored as an image history information of the pixel of interest.

42. The digital image quality enhancement method of claim 41, wherein when the pixel of interest is classified as the image pixel and the number of image pixels that continue in the upper direction of the pixel of interest are a predetermined number of p or greater, the number p is stored as the image history information of the pixel of interest.

43. The digital image quality enhancement method of claim 31, wherein when the pixel of interest is classified as a non-background pixel, the pixel of interest and a number of non-background pixels and the pixel of interest that continue in a left direction of the pixel of interest are stored as an image history information of the pixel of interest.

44. The digital image quality enhancement method of claim 43, wherein when the pixel of interest is classified as the non-background pixel and the pixel of interest and the number of non-background pixels that continue in the left direction of the pixel of interest are a predetermined number of r or greater, the number r is stored as the image history information of the pixel of interest.

45. The digital image quality enhancement method of claim 31, wherein the labeling of the pixel of interest comprises:
classifying the pixel of interest into any of a background feature pixel connected to the successive background pixels and an image feature pixel connected to the successive image pixels by using the history information stored regarding the pixel of interest;
background-labeling the pixel of interest classified into the background feature pixel where the pixel of interest belongs to the background area; and
image-labeling the pixel of interest classified into the image feature pixel where the pixel of interest belongs to the image area.

46. A digital image quality enhancement apparatus, comprising:
a classification unit classifying a pixel of interest in image data comprising pixels with a predetermined resolution and obtained by scanning a script comprising a combination of a background, a text, and an image into any of a text area, a background area, and an image area; and
an image quality enhancement unit enhancing a quality of an image to different degrees according to an area to which the pixel of interest belongs, wherein the classification unit comprises:
a color data conversion unit converting RGB color data of the pixel of interest into brightness/saturation data having a brightness component and a saturation component;
a pixel segmentation unit classifying the pixel of interest into any of a background pixel, an image pixel, and a text pixel by using the brightness/saturation data and outputting a result of the classification as a pixel segmentation signal;
a history information storage unit counting a number of successive background pixels before the pixel of interest using the pixel segmentation signal and storing the counted number of background pixels as background history information in a predetermined address corresponding to the pixel of interest, or counting a number of successive image pixels before the pixel of interest and storing the counted number of image pixels as image history information in the address corresponding to the pixel of interest; and
an area segmentation unit receiving the background or image history information regarding the pixel of interest from the history information storage unit, classifying the pixel of interest into any of the text area, the background area, and the image area by using the received background or image history information, labeling the pixel of interest as the text when the pixel of interest is classified into the text area, labeling the pixel of interest as the background when the pixel of interest is classified into the background area, and labeling the pixel of interest as the image when the pixel of interest is classified into the image area.

47. The digital image quality enhancement apparatus of claim 46, wherein the image quality enhancement unit improves the quality of the image by receiving a text labeling signal for the pixel of interest, a background labeling signal for the pixel of interest, or an image labeling signal for the pixel of interest from the area segmentation unit and classifies the brightness/saturation data of the text-labeled pixel of interest into at least two classes based on a predetermined brightness threshold.

48. The digital image quality enhancement apparatus of claim 46, wherein the image quality enhancement unit receives a text labeling signal of the pixel of interest, a background labeling signal of the pixel of interest, or an image labeling signal of the pixel of interest from the area segmentation unit and improves the image quality of an image-labeled pixel of interest using an unsharpened mask.

49. The digital image quality enhancement apparatus of claim 46, further comprising:
a smoothing unit performing smoothing to reduce a high frequency component of the brightness component of the brightness/saturation data using a low pass filter and outputting new brightness/saturation data having a smoothed brightness component,
wherein the pixel segmentation unit classifies the pixel of interest into one of the background pixel, the image pixel, and the text pixel using the new brightness/saturation data and outputting a result of the classification as a pixel segmentation signal.

50. A digital image quality enhancement apparatus, comprising:
a color data conversion unit converting RGB color data of a pixel of interest into color data having a brightness component and a saturation component;
a pixel segmentation unit segmenting the pixel of interest into a background pixel, an image pixel, or a text pixel using the brightness component and the saturation component;
a history information storage unit labeling the pixel of interest as a text area, a background area, or an image area using history information regarding the pixel of interest, wherein the history information is a number of successive background pixels or image pixels before the pixel of interest;
an image quality enhancement unit enhancing an image quality of the pixel of interest to degrees corresponding to the area labeled; and
an area segmentation unit determining whether the pixel of interest is a final pixel of which an image quality is to be improved.
